(19) United States
(12) Patent Application Publication
(10) Pub. No.: US 2022/0044278 A1
(43) Pub. Date: Feb. 10, 2022

(54) MULTI-TOUCH ATTRIBUTION

(71) Applicant: MARKETCAST LLC, Los Angeles, CA (US)

(72) Inventors: Tom Weiss, London (GB); Michael Collette, San Rafael, CA (US)

(73) Assignee: MARKETCAST LLC, Los Angeles, CA (US)

(21) Appl. No.: 17/395,188

(22) Filed: Aug. 5, 2021

Related U.S. Application Data
(60) Provisional application No. 63/061,181, filed on Aug. 5, 2020.
(60) Provisional application No. 63/149,869, filed on Feb. 16, 2021.
(60) Provisional application No. 63/172,186, filed on Apr. 8, 2021.

(51) Int. Cl. G06Q 30/02

(52) U.S. Cl. CPC G06Q 30/0246; G06Q 30/0274

(57) ABSTRACT

A determination of the relative influences on an advertising conversion that are credited to particular ad impressions across varied channels is facilitated through Shapley value calculation and assignment. A Shapley value is arrived at through assigning binary places in a Boolean value to a plurality of advertising channels and/or platforms, the Boolean values combinable to quickly determine for a particular advertising campaign which of the plurality of advertising channels and/or platforms was influential in a consumer's decision to initiate a transaction for goods or services associated with an advertisement rendered via the plurality of advertising channels and/or platforms. In this manner, an advertiser having arranged for messages associated with an advertising campaign to be distributed via disparate advertising channels and/or platforms may realize the relative performance of the various advertising channels and/or platforms.

### PRIORITY CLAIM

The present application is related to and/or claims the benefits of the earliest effective priority date and/or the earliest effective filing date of the below-referenced applications, each of which is hereby incorporated by reference in its entirety, to the extent such subject matter is not inconsistent herewith, as if fully set forth herein:

(1) this application constitutes a non-provisional of U.S. Provisional Patent Application No. 63/061,181, entitled SYSTEMS AND METHODS FOR THE APPLICATION OF SHAPELY VALUE TO MULTI-TOUCH ATTRIBUTION MODEL FOR VALUING IMPRESSIONS, naming Tom Weiss and Michael Collette as the inventors, filed Aug. 5, 2020, with attorney docket no. WLHLLC-20200804 (now MARK-1-1001), which is currently co-pending or is an application of which a currently co-pending application is entitled to the benefit of the filing date;

(2) this application constitutes a non-provisional of U.S. Provisional Patent Application No. 63/149,869, entitled CALCULATING A SHAPLEY VALUE, naming Tom Weiss and Michael Collette as the inventors, filed Feb. 16, 2021, with attorney docket no. MARK-1-1002, which is currently co-pending or is an application of which a currently co-pending application is entitled to the benefit of the filing date; and

(3) this application constitutes a non-provisional of U.S. Provisional Patent Application No. 63/172,186, entitled APPLYING GAME THEORY FOR MARKETING ATTRIBUTION, naming Tom Weiss and Michael Collette as the inventors, filed Apr. 8, 2021, with attorney docket no. MARK-1-1003, which is currently co-pending or is an application of which a currently co-pending application is entitled to the benefit of the filing date.

### FIELD OF THE INVENTION

This invention relates generally to digital advertising, and, more specifically, to multi-touch attribution.

### BACKGROUND OF THE INVENTION

Advertisers commonly run campaigns that are deliverable to prospective consumers via varied platforms. An advertiser may secure ad placements for delivery via televisions, newspapers, magazines, desktop computers, mobile devices, game consoles, social networks, outdoor billboards, etc. A prospective consumer for a particular product or service may therefore encounter numerous advertisements for that product or service via various advertising mediums, each such encounter often referenced as a “touch.” Having an understanding of the specific advertisements for a particular product or service, and the platforms through which the specific advertisements were encountered, that led to a conversion is useful. One exemplary benefit of such insight is the possible optimization of advertising messaging via the particular channels to obtain better performance with the same advertising budget. Advances in data modeling and analysis have led to improvements in “multi-touch attribution,” whereby a specific impression via a specific channel (i.e. a “touch”) can be credited (or attributed) commensurately with its respective level of influence in an eventual ad conversion. Particularly, determining separate attributions for the disparate impressions served via varying platforms (i.e. for the multiple touches) that led to the conversion is possible.

### SUMMARY

The instant application discloses a method, computer program product, and system operable to receive information indicative of one or more advertising impressions and indicative of a conversion, the conversion related to the one or more advertising impressions; and determine a level of influence associated with at least one of the one or more advertising impressions on the conversion.

The foregoing is a summary and thus contains, by necessity, simplifications, generalizations and omissions of detail; consequently, those skilled in the art will appreciate that the summary is illustrative only and is not intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1a is a panoptic drawing depicting a relationship between blocks representing an operational flow associated with calculating a Shapley value.

FIGS. 1b-1e are individual blocks from the panoptic drawing of FIG. 1a, the individual blocks representing a portion of an operational flow associated with calculating a Shapley value and connected with one another as shown via the panoptic drawings and the arrows and connector bubbles therein.

FIGS. 2-14 are a series of block diagrams depicting versions of an operational flow associated with multi-touch attribution.

### DETAILED DESCRIPTION

Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

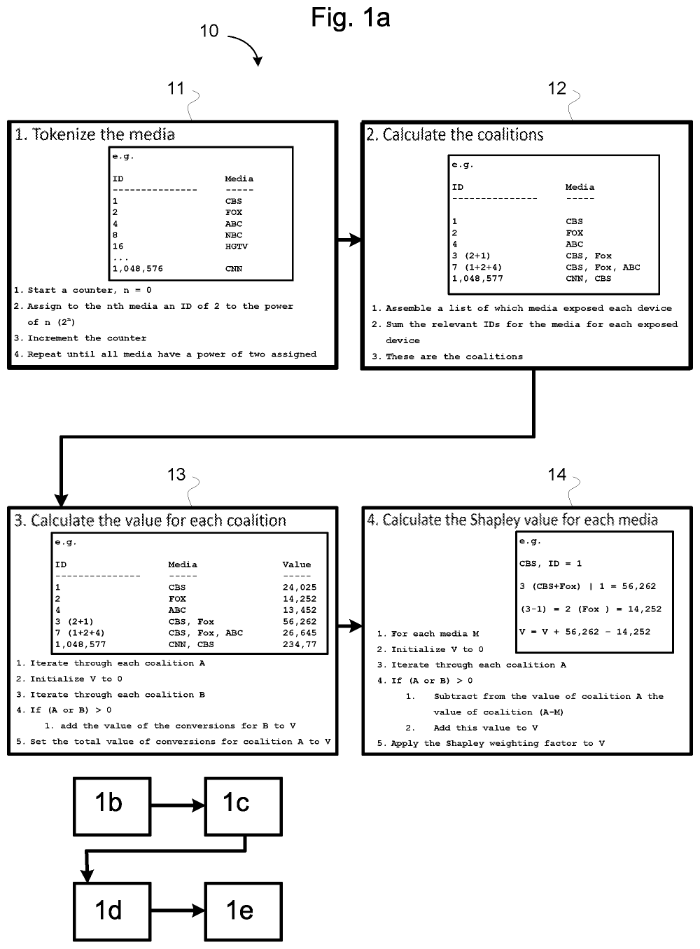

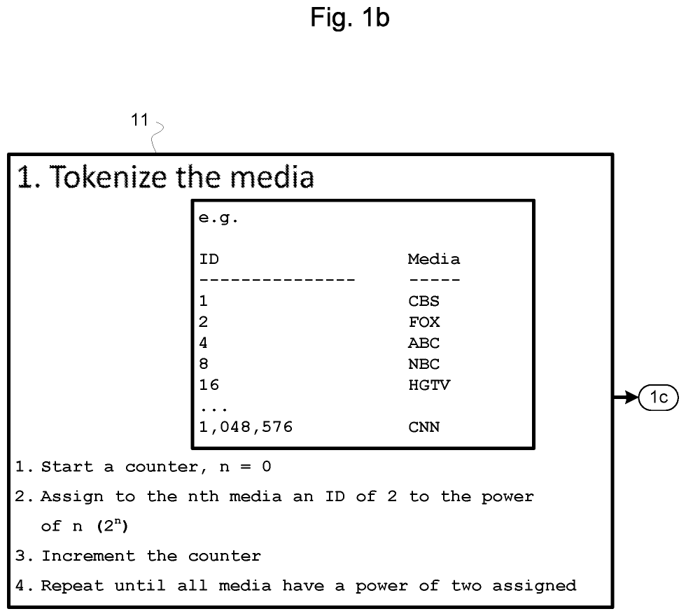

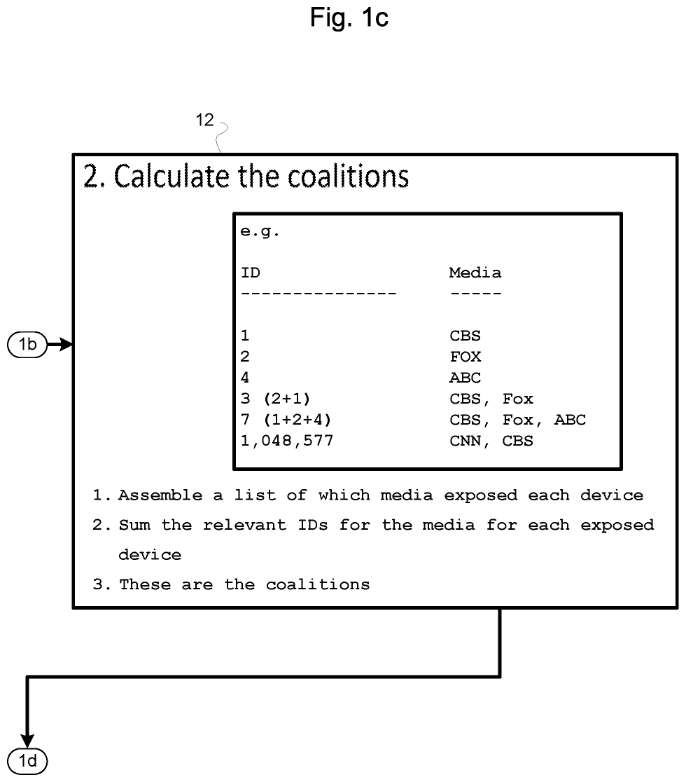

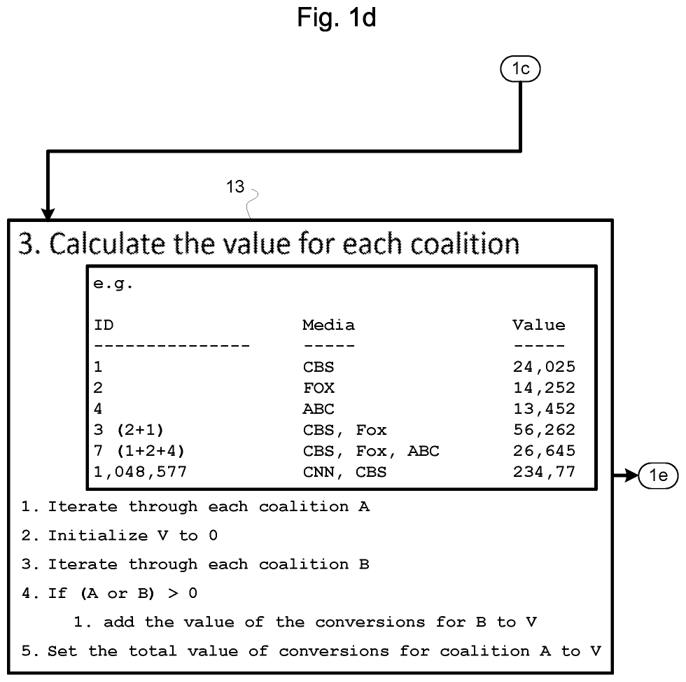

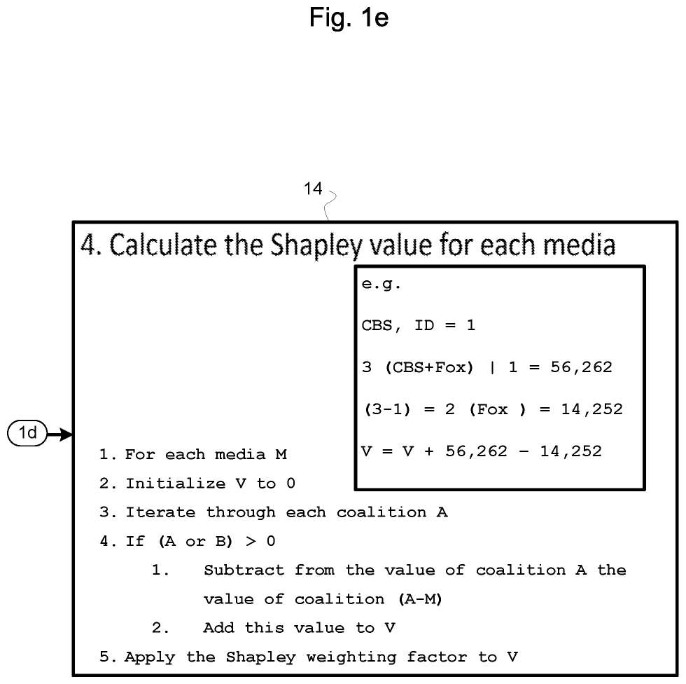

FIG. 1a is a panoptic drawing depicting a relationship between blocks representing an operational flow 10 associated with calculating a Shapley value. FIGS. 1b-1e are individual blocks from the panoptic drawing of FIG. 1a, the individual blocks representing a portion of an operational flow associated with calculating a Shapley value and connected with one another as shown via the panoptic drawings and the arrows and connector bubbles therein. With reference to FIG. 1b, at 11, the operational flow associated with calculating a Shapley value includes one or more operations operable to tokenize the media. With reference to FIG. 1c, at 12, the operational flow associated with calculating a Shapley value includes one or more operations operable to calculate the coalitions. With reference to FIG. 1d, at 13, the operational flow associated with calculating a Shapley value includes one or more operations operable to calculate the value for each coalition. With reference to FIG. 1e, at 14, the operational flow associated with calculating a Shapley value includes one or more operations operable to calculate the Shapley value for each media. As noted in one of the above-referenced provisional applications, the Shapley value is a form of aggregate analytics that considers the combination of views across networks resulting in conversions. As may be seen in FIGS. 1a-1e, a Shapley value is calculated by creating coalitions containing the different media for each combination of media.

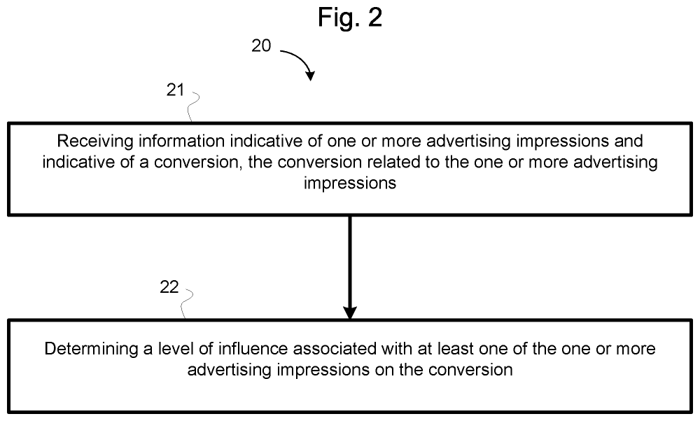

FIG. 2 is a block diagram of an operational flow 20 associated with multi-touch attribution. At 21, the operational flow associated with multi-touch attribution includes one or more operations operable to receive information indicative of one or more advertising impressions and indicative of a conversion, the conversion related to the one or more advertising impressions. For example, receiving information indicative of one or more advertising impressions associated with an ad campaign by a direct-to-consumer brand presented via a Digital news site, Linear TV network and cable VOD service (addressable) to promote a new mobile app, and information indicative of a number of downloads of the new mobile app. At 22, the operational flow associated with multi-touch attribution includes one or more operations operable to determine a level of influence associated with at least one of the one or more advertising impressions on the conversion. For example, determining a number of downloads of the new mobile app which can be associated with each media among the Digital news site, Linear TV network and cable VOD service (addressable).

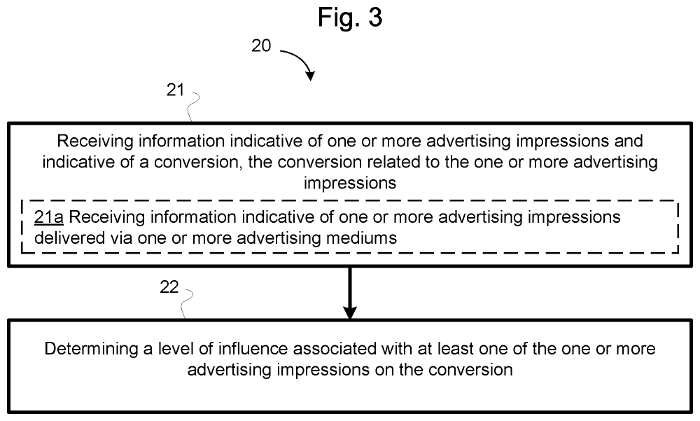

FIG. 3 is a block diagram of the operational flow 20 associated with multi-touch attribution in which operation 21 includes at least one optional operation. At 21a, the optional operation is operable to receive information indicative of one or more advertising impressions delivered via one or more advertising mediums. For example, receiving information indicative of one or more advertising impressions delivered via print, internet browsing, video, or a combination thereof.

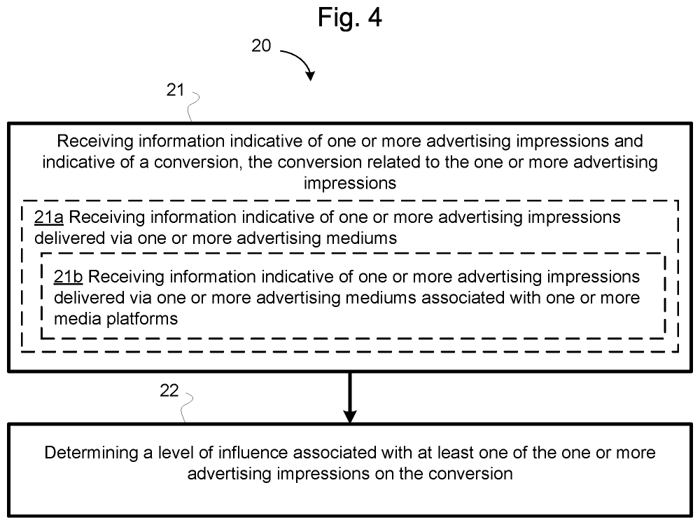

FIG. 4 is a block diagram of the operational flow 20 associated with multi-touch attribution in which operation 21a includes at least one optional operation. At 21b, the optional operation is operable to receive information indicative of one or more advertising impressions delivered via one or more advertising mediums associated with one or more media platforms. For example, receiving information indicative of one or more advertising impressions delivered via television viewing.

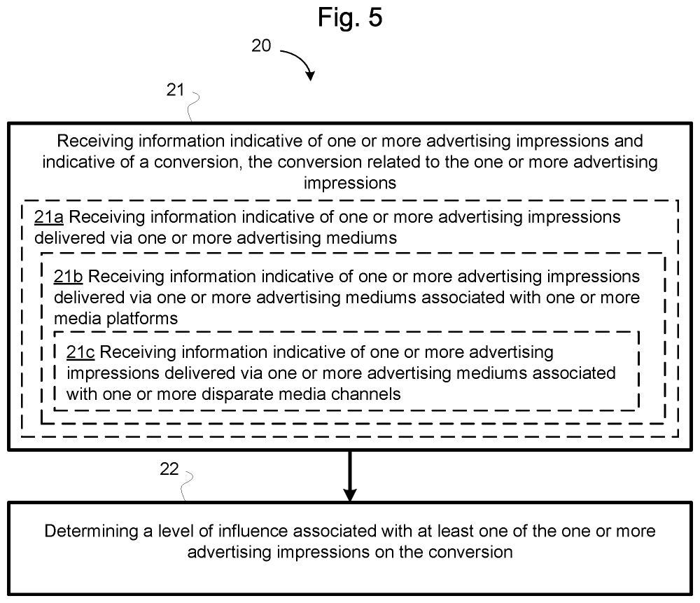

FIG. 5 is a block diagram of the operational flow 20 associated with multi-touch attribution in which operation 21b includes at least one optional operation. At 21c, the optional operation is operable to receive information indicative of one or more advertising impressions delivered via one or more advertising mediums associated with one or more disparate media channels. For example, receiving information indicative of one or more advertising impressions delivered via one or more television networks (ABC, CBS, FOX, NBC, etc.).

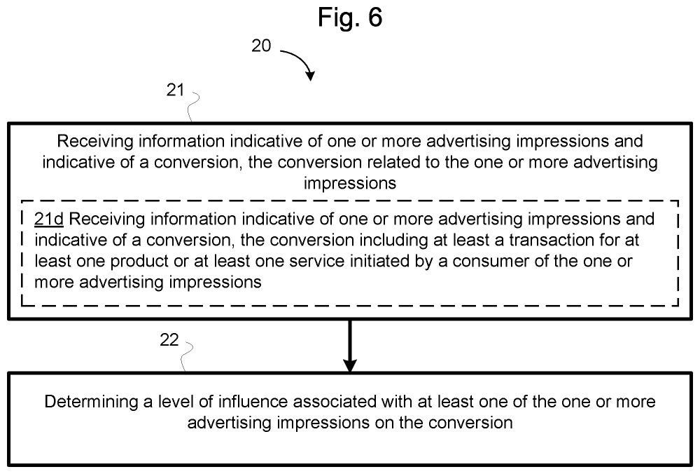

FIG. 6 is a block diagram of the operational flow 20 associated with multi-touch attribution in which operation 21 includes at least one optional operation. At 21d, the optional operation is operable to receive information indicative of one or more advertising impressions and indicative of a conversion, the conversion including at least a transaction for at least one product or at least one service initiated by a consumer of the one or more advertising impressions. For example, receiving information indicative of one or more advertising impressions associated with a new mobile app.

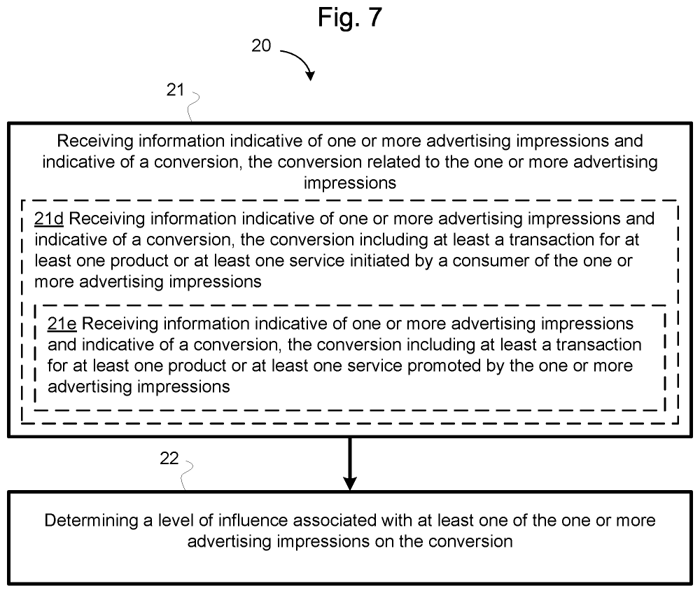

FIG. 7 is a block diagram of the operational flow 20 associated with multi-touch attribution in which operation 21d includes at least one optional operation. At 21e, the optional operation is operable to receive information indicative of one or more advertising impressions and indicative of a conversion, the conversion including at least a transaction for at least one product or at least one service promoted by the one or more advertising impressions. For example, receiving information indicative of a download of the new mobile app.

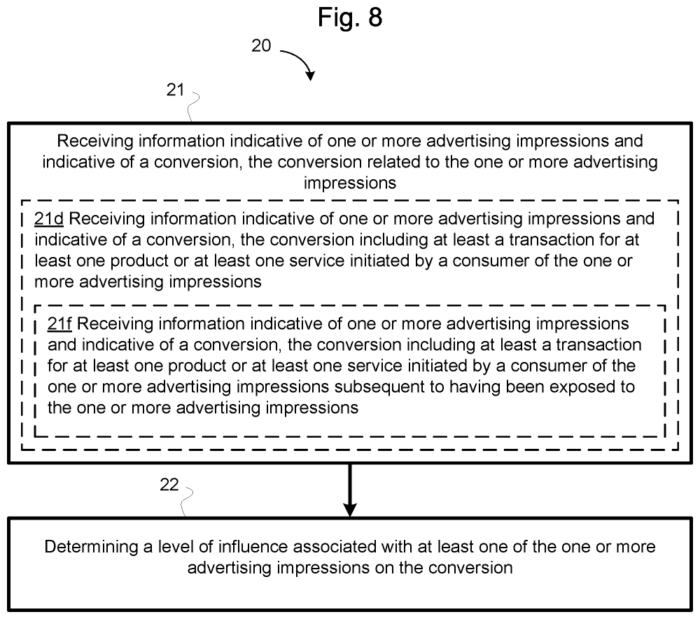

FIG. 8 is a block diagram of the operational flow 20 associated with multi-touch attribution in which operation 21d includes at least one optional operation. At 21f, the optional operation is operable to receive information indicative of one or more advertising impressions and indicative of a conversion, the conversion including at least a transaction for at least one product or at least one service initiated by a consumer of the one or more advertising impressions subsequent to having been exposed to the one or more advertising impressions. For example, receiving information indicative of a download of the new mobile app subsequent to the consumer downloading the app having been exposed to the one or more advertising impressions.

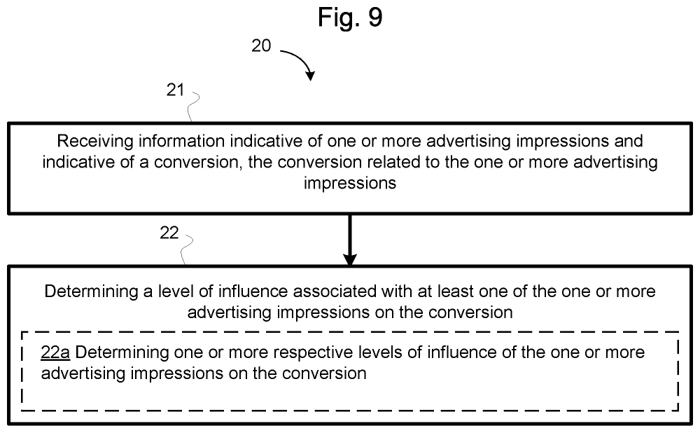

FIG. 9 is a block diagram of the operational flow 20 associated with multi-touch attribution in which operation 22 includes at least one optional operation. At 22a, the optional operation is operable to determine one or more respective levels of influence of the one or more advertising impressions on the conversion. For example, determining a level of influence on a download of a mobile app that was exerted by a website impression related to the mobile app vs. television advertising related to the mobile app.

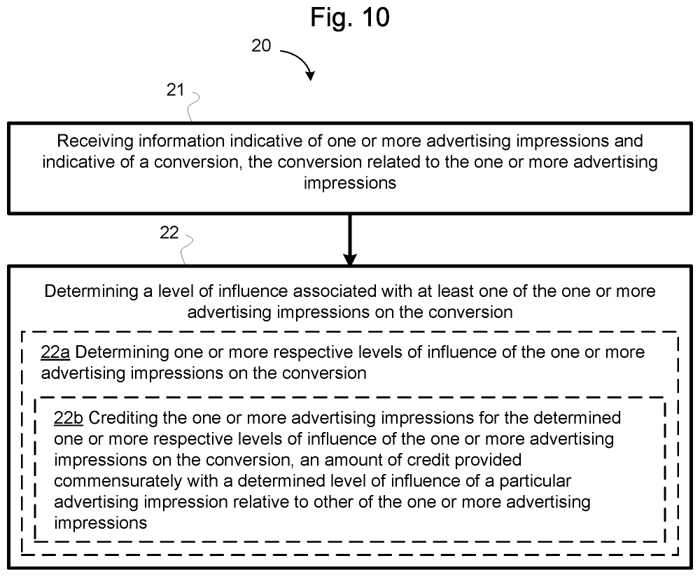

FIG. 10 is a block diagram of the operational flow 20 associated with multi-touch attribution in which operation 22a includes at least one optional operation. At 22b, the optional operation is operable to credit the one or more advertising impressions for the determined one or more respective levels of influence of the one or more advertising impressions on the conversion, an amount of credit provided commensurately with a determined level of influence of a particular advertising impression relative to other of the one or more advertising impressions. For example, determining that a website impression related to the mobile app containing a favorable review of the mobile app read by a consumer had more influence on a consumers decision to download the mobile app than a television advertisement for the mobile app to which the consumer was exposed, and crediting the website with different credit than the television advertiser.

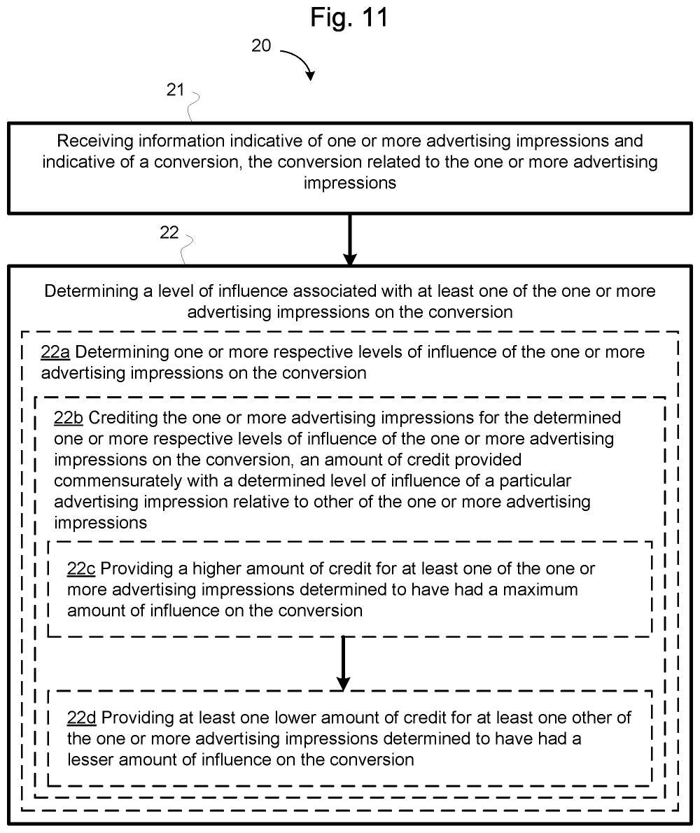

FIG. 11 is a block diagram of the operational flow 20 associated with multi-touch attribution in which operation 22b includes at least one optional operation. At 22c, the optional operation is operable to provide a higher amount of credit for at least one of the one or more advertising impressions determined to have had a maximum amount of influence on the conversion, and at 22d, the optional operation is operable to provide at least one lower amount of credit for at least one other of the one or more advertising impressions determined to have had a lesser amount of influence on the conversion. For example, determining that a website impression related to the mobile app containing a favorable review of the mobile app read by a consumer had more influence on a consumers decision to download the mobile app than a television advertisement for the mobile app to which the consumer was exposed, and crediting the website with more credit than the television advertiser.

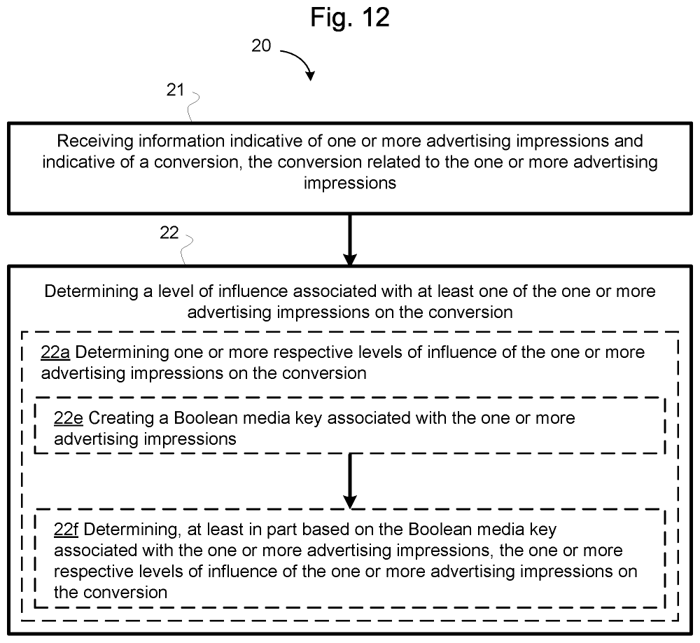

FIG. 12 is a block diagram of the operational flow 20 associated with multi-touch attribution in which operation 22a includes at least one optional operation. At 22e, the optional operation is operable to create a Boolean media key associated with the one or more advertising impressions. For example, allocating memory or storage for a large Boolean value, each bit of the Boolean value representing a channel through which a consumer may be exposed to an advertising impression. At 22f, the optional operation is operable to determine, at least in part based on the Boolean media key associated with the one or more advertising impressions, the one or more respective levels of influence of the one or more advertising impressions on the conversion. For example, determining that advertising impressions rendered via HGTV were more influential than advertising impressions rendered via CNN.

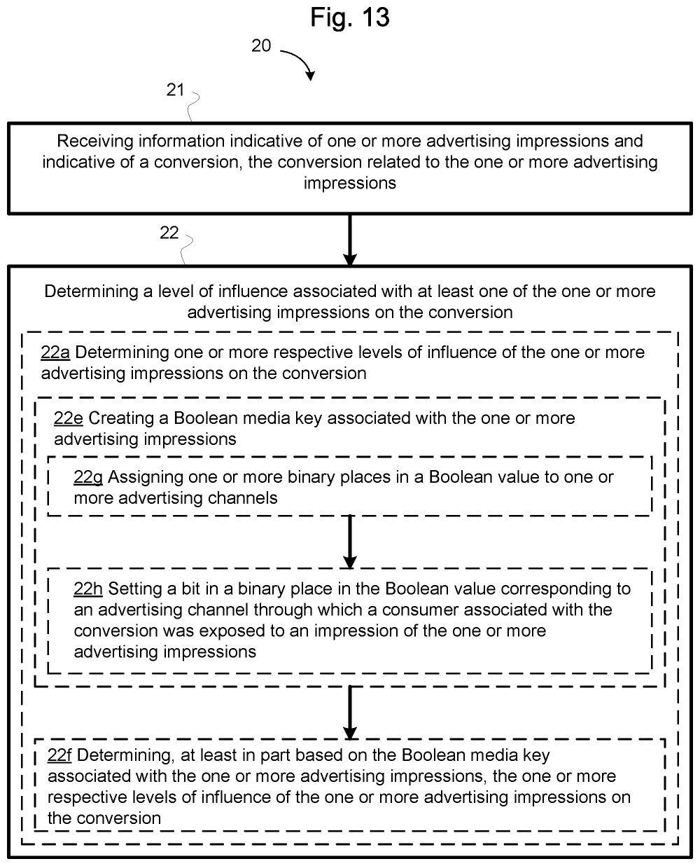

FIG. 13 is a block diagram of the operational flow 20 associated with multi-touch attribution in which operation 22e includes at least one optional operation. At 22g, the optional operation is operable to assign one or more binary places in a Boolean value to one or more advertising channels. For example, referring to FIG. 1b, tokenizing the media, as in assigning the zero bit to CBS, the one bit to FOX, the two bit to ABC, the three bit to NBC, the four bit to HGTV, the twenty bit to CNN, etc. At 22h, the optional operation is operable to set a bit in a binary place in the Boolean value corresponding to an advertising channel through which a consumer associated with the conversion was exposed to an impression of the one or more advertising impressions. For example, responsive to information received indicating an advertising impression was made via CNN, setting the twenty bit assigned to CNN to a value of 1.

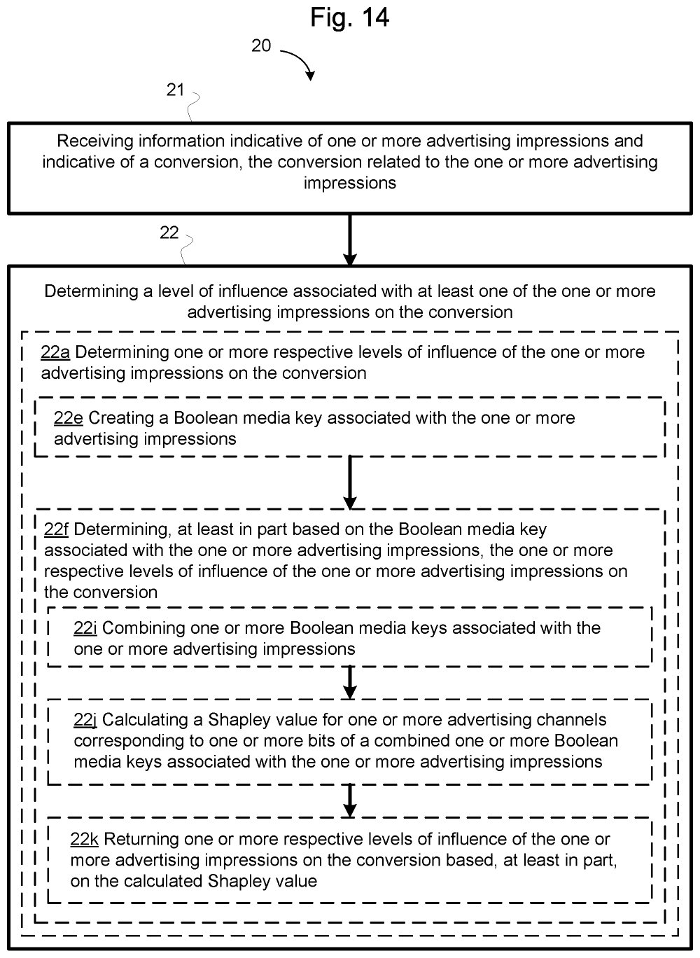

FIG. 14 is a block diagram of the operational flow 20 associated with multi-touch attribution in which operation 22f includes at least one optional operation. At 22i, the optional operation is operable to combine one or more Boolean media keys associated with the one or more advertising impressions. For example, using Boolean logical operations, such as Boolean logical OR, on two Boolean media keys. At 22j, the optional operation is operable to calculate a Shapley value for one or more advertising channels corresponding to one or more bits of a combined one or more Boolean media keys associated with the one or more advertising impressions. For example, splitting a number of downloads of a mobile app responsive to advertising impression between each media through which an ad impression was made in proportion to the value of the respective media. At 22k, the optional operation is operable to return one or more respective levels of influence of the one or more advertising impressions on the conversion based, at least in part, on the calculated Shapley value. For example, providing an indication, based on the Shapley value, of which media platforms were the best performers for a particular advertising campaign.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method, comprising:
receiving information indicative of one or more advertising impressions and indicative of a conversion, the conversion related to the one or more advertising impressions; and
determining a level of influence associated with at least one of the one or more advertising impressions on the conversion.

2. The method of claim 1, wherein receiving information indicative of one or more advertising impressions and indicative of a conversion, the conversion related to the one or more advertising impressions comprises:
receiving information indicative of one or more advertising impressions delivered via one or more advertising mediums.

3. The method of claim 2, wherein receiving information indicative of one or more advertising impressions delivered via one or more advertising mediums comprises:
receiving information indicative of one or more advertising impressions delivered via one or more advertising mediums associated with one or more media platforms.

4. The method of claim 3, wherein receiving information indicative of one or more advertising impressions delivered via one or more advertising mediums associated with one or more media channels comprises:
receiving information indicative of one or more advertising impressions delivered via one or more advertising mediums associated with one or more disparate media channels.

5. The method of claim 1, wherein receiving information indicative of one or more advertising impressions and indicative of a conversion, the conversion related to the one or more advertising impressions comprises:
receiving information indicative of one or more advertising impressions and indicative of a conversion, the conversion including at least a transaction for at least one product or at least one service initiated by a consumer of the one or more advertising impressions.

6. The method of claim 5, wherein receiving information indicative of one or more advertising impressions and indicative of a conversion, the conversion including at least a transaction for at least one product or at least one service initiated by a consumer of the one or more advertising impressions comprises:
receiving information indicative of one or more advertising impressions and indicative of a conversion, the conversion including at least a transaction for at least one product or at least one service promoted by the one or more advertising impressions.

7. The method of claim 5, wherein receiving information indicative of one or more advertising impressions and indicative of a conversion, the conversion including at least a transaction for at least one product or at least one service initiated by a consumer of the one or more advertising impressions comprises:
receiving information indicative of one or more advertising impressions and indicative of a conversion, the conversion including at least a transaction for at least one product or at least one service initiated by a consumer of the one or more advertising impressions subsequent to having been exposed to the one or more advertising impressions.

8. The method of claim 1, wherein determining a level of influence associated with at least one of the one or more advertising impressions on the conversion comprises:
determining one or more respective levels of influence of the one or more advertising impressions on the conversion.

9. The method of claim 8, wherein determining one or more respective levels of influence of the one or more advertising impressions on the conversion comprises:
crediting the one or more advertising impressions for the determined one or more respective levels of influence of the one or more advertising impressions on the conversion, an amount of credit provided commensurately with a determined level of influence of a particular advertising impression relative to other of the one or more advertising impressions.

10. The method of claim 9, wherein crediting the one or more advertising impressions for the determined one or more respective levels of influence of the one or more advertising impressions on the conversion, an amount of credit provided commensurately with a determined level of influence of a particular advertising impression relative to other of the one or more advertising impressions comprises:
providing a higher amount of credit for at least one of the one or more advertising impressions determined to have had a maximum amount of influence on the conversion; and
providing at least one lower amount of credit for at least one other of the one or more advertising impressions determined to have had a lesser amount of influence on the conversion.

11. The method of claim 8, wherein determining one or more respective levels of influence of the one or more advertising impressions on the conversion comprises:
creating a Boolean media key associated with the one or more advertising impressions; and
determining, at least in part based on the Boolean media key associated with the one or more advertising impressions, the one or more respective levels of influence of the one or more advertising impressions on the conversion.

12. The method of claim 11, wherein creating a Boolean media key associated with the one or more advertising impressions comprises:
assigning one or more binary places in a Boolean value to one or more advertising channels; and
setting a bit in a binary place in the Boolean value corresponding to an advertising channel through which a consumer associated with the conversion was exposed to an impression of the one or more advertising impressions.

13. The method of claim 11, wherein determining, at least in part based on the Boolean media key associated with the one or more advertising impressions, the one or more respective levels of influence of the one or more advertising impressions on the conversion comprises:
combining one or more Boolean media keys associated with the one or more advertising impressions;
calculating a Shapley value for one or more advertising channels corresponding to one or more bits of a combined one or more Boolean media keys associated with the one or more advertising impressions; and
returning one or more respective levels of influence of the one or more advertising impressions on the conversion based, at least in part, on the calculated Shapley value.

14. A computer program product, comprising:
at least one non-transitory computer-readable medium including at least one or more instructions which, when executed on the computer device, cause the computing device to perform one or more operations including at least:
receiving information indicative of one or more advertising impressions and indicative of a conversion, the conversion related to the one or more advertising impressions; and
determining a level of influence associated with at least one of the one or more advertising impressions on the conversion.

15. A system, comprising:
a computing device; and
at least one non-transitory computer-readable medium including at least one or more instructions which, when executed on the computer device, cause the computing device to perform one or more operations including at least:
receiving information indicative of one or more advertising impressions and indicative of a conversion, the conversion related to the one or more advertising impressions; and
determining a level of influence associated with at least one of the one or more advertising impressions on the conversion.
